(19) United States
(12) Patent Application Publication
(10) Pub. No.: US 2009/0286532 A1
(43) Pub. Date: Nov. 19, 2009

(54) METHOD AND SYSTEM FOR MANAGING PAGING IN WIRELESS COMMUNICATION NETWORK

(75) Inventors: Anshuman Nigam, Bangalore (IN); Vadlapudi Tirumala Sreehari Vara Prasad, Bangalore (IN)

Correspondence Address: THE FARRELL LAW FIRM, LLP, 290 Broadhollow Road, Suite 210E, Melville, NY, 11747, US

(73) Assignee: SAMSUNG ELECTRONICS CO., LTD., Suwon-si (KR)

(21) Appl. No.: 12/467,779

(22) Filed: May 18, 2009

(30) Foreign Application Priority Data
May 16, 2008 (IN) 1202/CHE/2008

(51) Int. Cl. H04W 4/00

(52) U.S. Cl. 455/426.1

(57) ABSTRACT

A method and system for managing paging in a wireless communication network is provided. The method includes receiving a paging frame indicator during a paging listening interval. The paging frame indicator includes information associated with one or more paging messages. The method then determines one or more frames associated with the one or more paging messages from the paging frame indicator. Further, the method manages time period associated with at least one of active mode and sleep mode in the paging listening interval.

### CLAIMS OF PRIORITY

This application claims priority to an application entitled “METHOD AND SYSTEM FOR MANAGING PAGING IN WIRELESS COMMUNICATION NETWORK” filed in the Indian Patent Office on May 16, 2008 and assigned Serial No. 1202/CHE/2008, the contents of which are incorporated herein by reference.

### FIELD OF THE INVENTION

The present invention relates to managing communication in communication network. More particularly the present invention relates to managing paging in a wireless communication network.

### BACKGROUND OF THE INVENTION

Over a period of time, technology associated with communication network has evolved significantly. The communication network allows a plurality of communication devices to communicate with each other. The communication network can be a wire lined communication network or a wireless communication network. An example of wire lined communication network is public switched telephone network (PSTN). Examples of wireless communication network includes, but are not limited to, Global system for mobile communications (GSM) network, Code Division Multiple Access (CDMA) network, communication network associated with IEEE 802.16 group of wireless standards. An example of communication network associated with IEEE 802.16 group of wireless standards is WiMAX standards.

WiMAX is a telecommunications technology that enables exchange of audio/video data between communication devices in a wireless environment. Examples of communication devices include but are not limited to mobile phones, personal digital assistance (PDA), laptops and computers. A communication device for example a mobile device can communicate with other mobile device through a wireless communication network within a wireless communication range.

The wireless communication range in the wireless communication network is divided into a plurality of regions called radio cells. Each radio cell has a base station. A base station is a radio transmitter and receiver used for transmitting and receiving voice and data signal to and from communication devices in a radio cell. Hence, one communication device can communicate with the other communication devices in the wireless communication network through one or more base stations.

However, the clarity of the communication is dependent on various factors. The various factors include battery power of the communication device, network signal strength, and the like. Hence, managing battery power of the communication device is one of the essential factors for effective communication.

For managing the battery power of the communication device, typically the communication devices in each cell periodically switches from active mode to inactive mode (sleep mode) and vise-versa for predefined time intervals. The active mode is defined as a predefined time interval during which the communication device is active and may receive paging messages. However, sleep mode is a state in which the communication device effectively turns itself off and becomes unavailable for predetermined time interval.

Thus communication device achieves power saving by turning off parts of the communication device in a controlled manner, when it is not actively transmitting or receiving data. Therefore, the sleep mode and active mode in the communication device is activated periodically to conserve battery power of the communication device. Further this method allows communication devices to operate for longer durations without recharging the battery of the communication device.

Each of the plurality of communication devices for effectively managing their sleep mode and active mode synchronizes their active mode time duration and sleep mode time duration with base station. Hence, in a radio cell each of the one or more communication devices synchronizes their time period of active mode and time period of sleep mode with a base station that is associated with the radio cell. Thus, the base station and each communication devices in the cell are in sync with each other. This active mode is further referred to as the paging listening interval. It is to be noted that a plurality of communication devices can correspond to one paging listening interval.

In establishing the communication channel between a first communication device and a second communication device, the base station initially receives a request from a communication device, for example the first communication device. Thereafter, the base station sends a paging message to the second communication device during its paging listening interval. The second communication device then receives the paging message when it is in active mode during a paging listening interval. The paging message provides information about the request for establishing communication channel to the second communication channel. The paging listening interval is associated with a plurality of frames. Hence, the paging message is received in any of the frame from the plurality of frames associated with the paging listening interval.

Therefore, for establishing a communication channel, the second communication device remains in active mode from the start of the paging listening interval until it receives a paging message in the paging listening interval. However, there may be a case that the second communication device receives the paging message in a last frame of the plurality of frames. Hence, the second communication device in this case was active for all the plurality of frames in the paging listening interval as the paging message was received in the last frame. Hence there exists a need to efficiently manage paging in the wireless communication network.

### SUMMARY OF THE INVENTION

In an embodiment, a method for managing paging in a wireless communication network is provided. The method performed at a communication device includes receiving a paging frame indicator during a paging listening interval. The paging frame indicator includes information associated with one or more paging messages. The method then determines one or more frames associated with the one or more paging messages from the paging frame indicator. Further, the method manages time period associated with at least one of active mode and sleep mode in the paging listening interval based on the one or more frames determined from the paging frame indicator.

In another embodiment, a method for managing paging in a wireless communication network is provided. The method performed at a base transceiver station includes identifying one or more frames associated with one or more paging messages during a paging listening interval. The method then sends a paging frame indicator during the paging listening interval, wherein the paging frame indicator includes information associated with the one or more frames that are associated with the one or more paging messages.

In yet another embodiment, a communication device is provided. The communication device includes a transceiver and a processor. In the embodiment, the transceiver receives a paging frame indicator during a paging listening interval. The paging frame indicator includes information associated with one or more paging messages. The processor then determines one or more frames associated with the one or more paging messages from the paging frame indicator. Thereafter, the processor manages time period associated with at least one of active mode and sleep mode in the paging listening interval based on the one or more frames.

In still another embodiment, a base transceiver station is provided. The base station includes a transceiver and a processor. The processor identifies one or more frames associated with one or more paging messages during a paging listening interval. Further, the transceiver sends a paging frame indicator during the paging listening interval, wherein the paging frame indicator includes information associated with the one or more frames associated with the one or more paging messages.

The features and advantages of the present invention will become more apparent from the ensuing detailed description of the invention taken in conjunction with the accompanying drawings.

### BRIEF DESCRIPTION OF THE FIGURES

The accompanying figure, similar reference numerals may refer to identical or functionally similar elements. These reference numerals are used in the detailed description to illustrate various embodiments and to explain various aspects and advantages of the present disclosure.

FIG. 1 illustrates an exemplary environment, where various embodiments of the present invention can be practiced;

FIG. 2 illustrates a base transceiver station, in accordance with one embodiment of the present invention;

FIG. 3 illustrates a communication device, in accordance with one embodiment of the present invention;

FIG. 4 illustrates a timing diagram depicting a method for managing paging in a wireless communication network, in accordance with one embodiment of the present invention;

FIG. 5 illustrates a flow chart depicting a method for managing paging in a wireless communication network, in accordance with another embodiment of the present invention;

FIG. 6 illustrates a flow chart depicting a method for managing paging in a wireless communication network, in accordance with yet another embodiment of the present invention; and

FIG. 7 illustrates a flow chart depicting a method for managing paging in a wireless communication network, in accordance with still another embodiment of the present invention.

Persons skilled in the art will appreciate that elements in the figure is illustrated for simplicity and clarity and may have not been drawn to scale. For example, the dimensions of some of the elements in the figure may be exaggerated relative to other elements to help to improve understanding of various embodiments of the present disclosure.

### DETAILED DESCRIPTION

The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are no where intended to represent a chronological order, as and where stated otherwise. A set is defined as a non-empty set including at least one element.

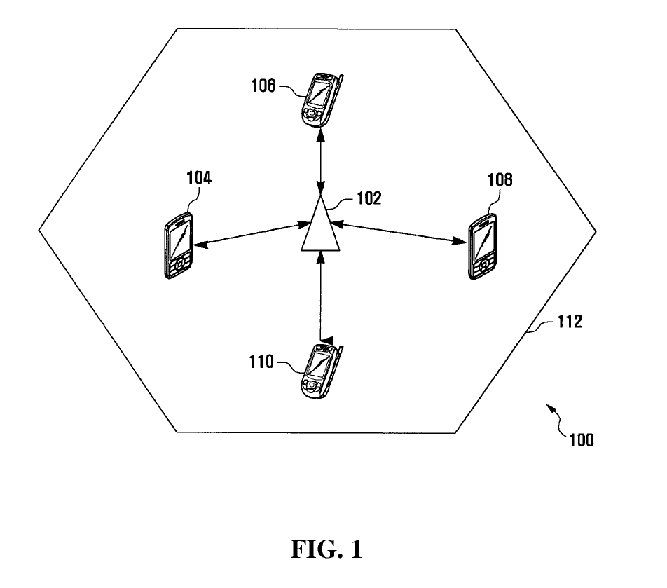

FIG. 1 illustrates an exemplary environment 100, where various embodiments of the present invention can be practiced. The environment 100 includes a Base Transceiver Station (BTS) and a plurality of communication devices. For example, the environment 100 includes a BTS 102, a communication device 104, a communication device 106, a communication device 108, and a communication device 110. However, only one BTS and four communication devices are shown in the environment 100, it will be apparent to the person ordinary skilled in the art that the environment 100 includes more number of BTS and more number of communication devices.

The BTS 102 enables communication between a plurality of communication devices in a wireless communication range, for example a wireless communication range 112. The examples of the communication devices 104, 106, 108 and 110 include, but are not limited to, Mobile phones, Personal Digital Assistance (PDA), and Computers. For the sake of clarity and for the purpose of this description, the communication devices 104, 106, 108 and 110 will also be referred as mobile device 104, 106, 108 and 110. However, it no where limits the scope of the invention to mobile device and hence the person ordinary skilled in the art can use any other communication device.

The plurality of communication devices are capable of communicating with each other through a communication network. In an embodiment, the communication devices 104, 106, 108 and 110 are capable of communicating with each other through a wireless communication network. Examples of wireless communication network include but are not limited to, Global System for Mobile communications (GSM), General Packet Radio Service (GPRS), WiMAX, and Code division multiple access (CDMA).

In an embodiment, the communication devices 104, 106, 108 and 110 are capable of communicating with each other through WiMAX communication technology. Hence, in WiMAX communication technology, the communication device 104 for establishing communication channel with the communication device 106 sends a communication request to BTS 102. Thereafter, the BTS 102 will send a Paging Frame Indicator (PFI) in the paging listening interval corresponding to the communication device 106, after receiving the request from the communication device 104.

The PFI includes information about one or more frames that can carry paging message for the communication device 106 and all the other communication devices that correspond to the paging listening interval. In an embodiment, the paging listening interval is associated with a plurality of frame. Hence, the communication device 106 will identify one or more frames from the plurality of frames that can receive paging messages in the paging listening interval.

Therefore, the communication device 106 can be in active mode for the identified one or more frames in which the paging message is expected to receive. Further, the communication device 106 can be in a sleep mode during the frame(s) in which the paging message is not expected to be received.

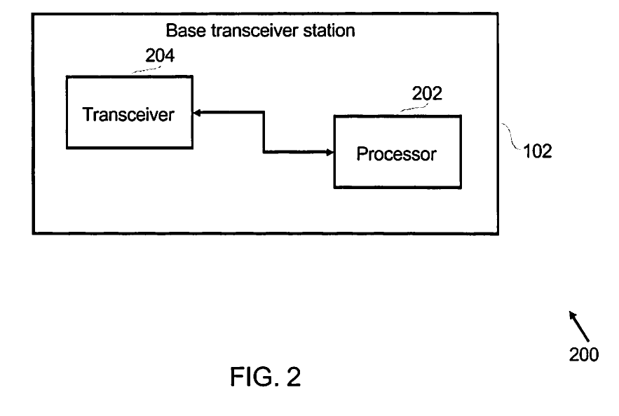

FIG. 2 illustrates a base transceiver station, in accordance with one embodiment of the present invention. To explain the communication device, references will be made to FIG. 1. However, it will be apparent to a person ordinarily skilled in the art that the present embodiment can be explained with the help of any other suitable embodiment of the present invention. The Base Transceiver Station (BTS) 102 includes a processor 202 and a transceiver 204.

In the environment 100, the BTS 102 receives a request from the communication device 104 for establishing communication channel with the communication device 106. Thereafter, the processor 202 in the BTS 102 identifies one or more frames in which a paging message can be sent to the communication device 106. In an embodiment, the paging message notifies a communication device, for example the communication device 106, about a request for establishing communication channel. In an embodiment, the processor 202 assembles information associated with the one or more frames associated with the paging message in a Paging Frame Indicator (PFI).

The transceiver 204 in the BTS 102 then sends the PFI to the communication device 106 during a paging listening interval. In an embodiment, the paging listening interval is associated with a plurality of frames. Therefore, the transceiver 204 sends information about the one or more frames that are associated with the paging message to the communication device 106 during the paging listening interval. In an embodiment, the transceiver 204 will send information about the one or more frames that can include paging message, to the communication device 106. In an embodiment, the PFI is sent in a first frame in the paging listening interval.

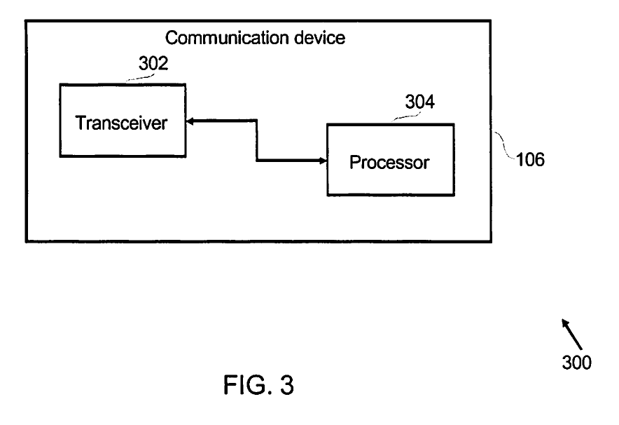

FIG. 3 illustrates a communication device, in accordance with one embodiment of the present invention. To explain the communication device, references will be made to FIG. 1 and FIG. 2. However, it will be apparent to a person ordinarily skilled in the art that the present embodiment can be explained with the help of any other suitable embodiment of the present invention. The communication device 106 includes a transceiver 302 and a processor 304.

The transceiver 302 in the communication device 106 receives a Paging Frame Indicator (PFI) during a paging listening interval. The paging frame indicator includes information associated with one or more paging messages. In an embodiment, the information associated with one or more paging messages are information about one or more frames that can include paging messages for a communication device. In an embodiment, the transceiver 302 receives the PFI sent by the transceiver 202 of the BTS 102.

The processor 304 then processes the PFI received by the communication device 106. Hence, the processor 304 determines one or more frames from the PFI. The one or more frames determined are associated with the one or more paging messages. In an embodiment, the processor 304 identifies the one or more frames that include paging message, from the information received in the PFI. The processor 304 then manages time period associated with at least one of active mode and sleep mode in the paging listening interval based on the one or more frames associated with the paging message.

In an embodiment, the paging listening interval is associated with a plurality of frames. Hence, in an embodiment, the communication device 106 during the paging listening interval is in active mode during the one or more frames that are determined by the processor 304 and are associated with the paging message. Similarly, the communication device 106 during the paging listening interval is in sleep mode during one or more frames that are not associated with paging messages and are not determined by the processor 304.

In an embodiment, the processor 304 determines a first set of frame numbers and a second set of frame numbers after receiving the PFI in the paging listening interval. In an embodiment, the first set of frame numbers are one or more frame numbers that can include paging message during the paging listening interval. In an embodiment, the second set of frame numbers are one or more frames that are not associated with the paging messages. Hence, the communication device 106 is in the active mode during the first set of frame numbers in the paging listening interval. Similarly, the communication device 106 goes in a sleep mode during the second set of frames in the plurality of frames.

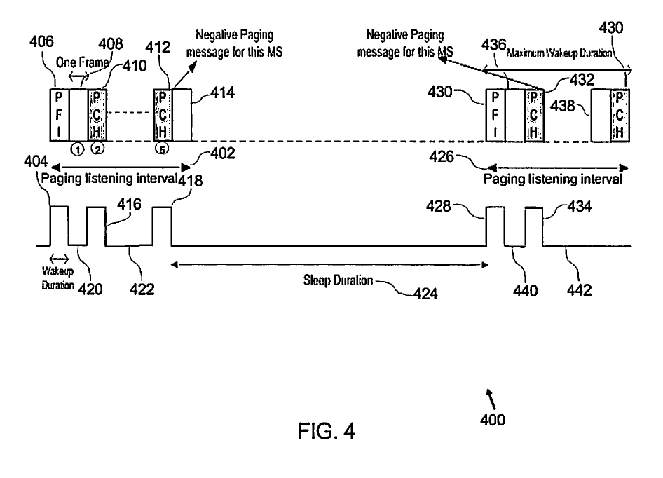

FIG. 4 illustrates a timing diagram depicting a method for managing paging in a wireless communication network, in accordance with one embodiment of the present invention. To explain the method 400, references will be made to FIG. 1. However, it will be apparent to a person ordinarily skilled in the art that the present embodiment can be explained with the help of any other suitable embodiment of the present invention.

The method 400 includes a plurality of frames that are received by a communication device, for example a communication device 106. However, it will be apparent to a person ordinary skilled in the art that the present embodiment can include more or fewer number of frames as depicted in FIG. 4. Further, the order of the frames may also vary.

In the environment 100, the BTS 102 receives a request from the communication device 104 for establishing communication channel with the communication device 106. The BTS 102 after receiving the request identifies one or more frames in which a paging message can be sent to the communication device 106. In an embodiment, the paging message notifies a communication device, for example the communication device 106, about a request for establishing communication channel. The BTS 102 then sends a Paging Frame Indicator (PFI) to the communication device 106. Thereafter the communication device 106 receives a Paging Frame Indicator (PFI) during a paging listening interval. In an embodiment, the PFI includes information about the frames that can include paging message.

In the environment 400, the communication device 106 receives the PFI, for example a PFI 406, during the paging listening interval 402. The paging listening interval is associated with a plurality of frames. For example, the paging listening interval 402 includes a frame 406, a frame 408, a frame 410, a frame 412, and frame 414. In an embodiment, the PFI is received at a predefined frame number in the plurality of frames during the paging listening interval. Hence, in the environment 400, the PFI 406 is received at a first frame of the paging listening interval 402. Hence, the communication device will be in active mode during the first frame in the paging listening interval 402.

As shown in the environment 400, the communication device 106 is in active mode during a time frame 404 corresponding to the frame 406. Thereafter, the communication device 106 can determine one or more frames that are associated with the paging message based on the information received in the PFI. For example, the communication device 106 after receiving the PFI 406 identifies that a frame 410 and a frame 412 are the two frames in which it is expected to receive paging message. Therefore, the communication device will be in active mode only during the time frame corresponding to the frame 408 and the frame 412. For example, the communication device is in active mode during a time frame 416 and a time frame 418 corresponding to the frame 408 and 412 for receiving the paging message.

In an embodiment, the communication device identifies one or more frame numbers that can include the paging message. For example, the communication device 106 identifies a frame number two and a frame number five from the PFI 406. Thus, the communication device 106 identifies that the frame number two and the frame number five are the two frames in which the paging message can be received. Therefore, the communication device 106 will be in active mode during a time frame corresponding to the identified two frames in the paging listening interval. For example, the communication device 106 will be in active mode during a time frame 416 and a time frame 418 corresponding to the frame number two and frame number five.

Further, the communication device 106 will be in sleep mode during frames that are not associated with paging messages in the paging listening interval 402. For example, the communication device 106 will be in sleep mode during frame 408, frame 414 and frames that are between the frame 410 and the frame 412 (The frames between the frame 410 and the frame 412 are not shown in FIG. 4). In other words, the communication device 106 will be in sleep mode in one or more frames excluding the frame number two and the frame number five. Hence, the communication device will be in sleep mode during a time frame 420, a time frame 422 and a time frame 424.

Similarly, during paging listening interval 426, the communication device 106 will be in active mode during a time frame 428 to receive a PFI 430. Thereafter, the communication device 106 will be in active mode during a time frame corresponding to a frame 432 based on the paging message information received in the PFI 430. The active mode corresponding to the frame 432 is depicted in a time frame 434. Further, the communication device 106 will be in sleep mode during a time frame corresponding to a frame 436 and a frame 438. The sleep mode corresponding to the frame 436 and the frame 438 is depicted at a time frame 440 and a time frame 442.

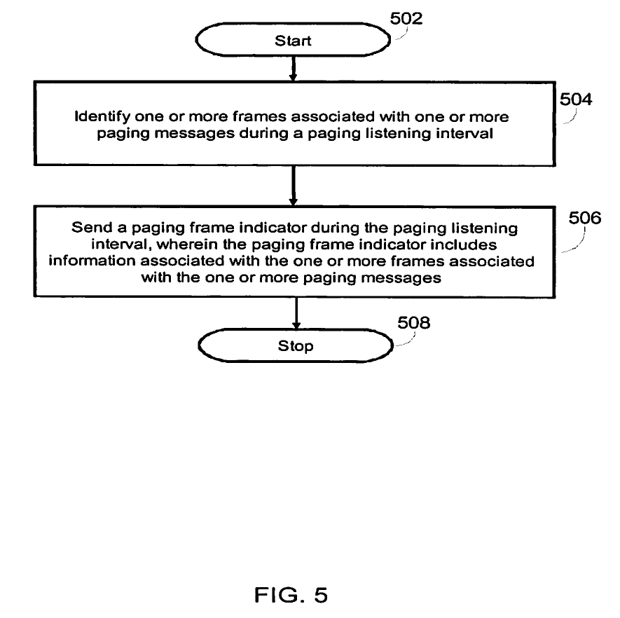

FIG. 5 illustrates a flow chart depicting a method for managing paging in a wireless communication network, in accordance with another embodiment of the present invention. To explain the method 500, references will be made to FIG. 1. However, it will be apparent to a person ordinarily skilled in the art that the present embodiment can be explained with the help of any other suitable embodiment of the present invention. The method 500 can also include more or fewer number of steps as depicted in FIG. 5. Further, the order of the steps may also vary. In an embodiment, the method is performed by the communication device.

At step 502 the method is initiated. In an embodiment, the method is performed at the base station. The BTS 102 establishes communication channel between a plurality of communication devices. For example, in the environment 100, the communication device 104 sends a request to the BTS 102 to establish communication channel with the communication device 106. At step 504, the method identifies one or more frames that are associated with one or more paging messages during a paging listening interval. In an embodiment, the one or more frames associated with the paging messages are one or more frames in which the paging message can be sent to the communication device 106.

In an embodiment, the information associated with the one or more frames are assembled in a Paging Frame Indicator (PFI). Hence, the PFI includes information associated with the one or more frames that are associated with the paging message. At step 506, the method sends the PFI during paging listening interval. In an embodiment, the paging listening interval is a plurality of frames during which a communication device receives data from BTS. In an embodiment, the method sends the paging frame indicator in a first frame of the paging listening interval. Hence, the communication device can receive information about paging messages before receiving a paging message from the BTS.

In an embodiment, the paging frame indicator is sent in a first channel in the first frame of the paging listening interval. In another embodiment, the paging frame indicator is sent as a Type Length Value (TLV) field in a Downlink Medium Access Protocol (DL_MAP) message of the first frame of the paging listening interval. In yet another embodiment, the paging frame indicator is sent as a first bit format. In an embodiment, the first bit format includes arranging bit values in the PFI so that the frame that carry paging message can be identified.

Hence the first bit format is arranged based on frames and/or frame numbers that can include paging message. For example, if frame number two and frame number four are two frames that can include paging message then bit corresponding to the frame number two and the frame number four is set. The above example is solely for the sake of clarity and no where limits the scope of the invention to the above example. However, a person ordinary skilled in the art can use any bit format for identifying the frames associated with paging message in the PFI. At step 508 the method is terminated.

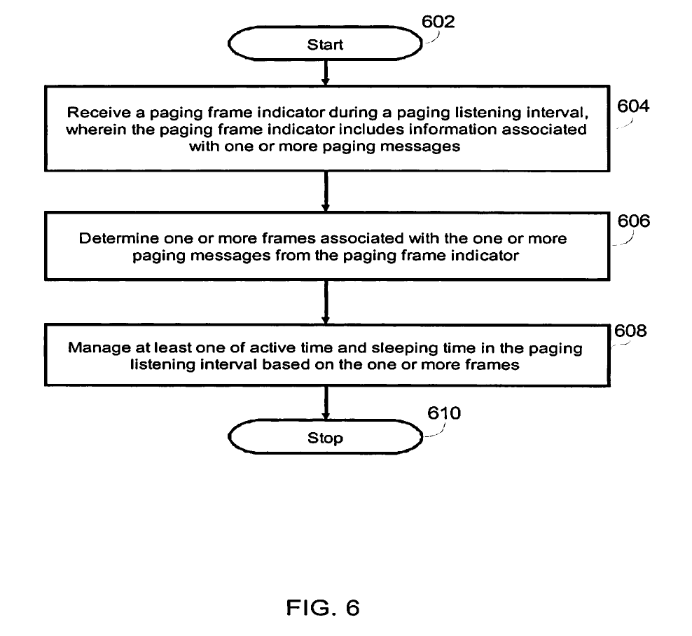

FIG. 6 illustrates a flow chart depicting a method for managing communication in a wireless communication network, in accordance with yet another embodiment of the present invention. To explain the method 600, references will be made to FIG. 1. However, it will be apparent to a person ordinarily skilled in the art that the present embodiment can be explained with the help of any other suitable embodiment of the present invention. The method 600 can also include more or fewer number of steps as depicted in FIG. 6. Further, the order of the steps may also vary. In an embodiment, the method is performed at a communication device. In another embodiment, the managing paging in a wireless communication network includes handling paging in IEEE 802.16e standard and/or IEEE802.16m standards.

At step 602 the method is initiated. At step 604 a paging frame indicator is received during a paging listening interval. The paging frame indicator includes information associated with one or more paging messages. In an embodiment, the method 600 periodically monitors paging frame indicators during one or more paging listening intervals. In an embodiment, the method receives the paging frame indicator in a first frame of the paging listening interval. Hence, the communication device receives information about paging messages before receiving a paging message from the BTS 102.

In an embodiment, the paging frame indicator is received in a first channel in the first frame of the paging listening interval. In another embodiment, the paging frame indicator is received as a Type Length Value (TLV) field in a Downlink Medium Access Protocol (DL_MAP) message of the first frame of the paging listening interval. In yet another embodiment, the paging frame indicator is received as a first bit format.

In an embodiment, the first bit format includes arranging bit values in the PFI so that the frame that carry paging message can be identified. Hence the first bit format is arranged based on frames and/or frame numbers that can include paging message. For example, if frame number three and frame number four are two frames that can include paging message then bit corresponding to frame number three and frame number four is set. The above example is solely for the sake of clarity and no where limits the scope of the invention to the above example. However, a person ordinary skilled in the art can use any bit format for identifying the frames associated with paging message in the PFI.

At step 606, the one or more frames associated with the one or more paging messages from the PFI are determined. In an embodiment, the method identifies one or more frames in which the paging message is received during the paging listening interval. In another embodiment, the method identifies one or more frames in which the paging message will not be received. At step 608, the method manages time period associated with at least one of active mode and sleep mode in the paging listening interval based on the one or more frames associated with the one or more paging messages.

In an embodiment, the method 600 manages time period associated with sleep mode based on identifying one or more frames in which the paging message is received during the paging listening interval. For example, if the method identifies that the paging message can be received in frame number two and frame number five in a plurality of frames received during the paging listening interval, then the method can activate sleep mode in the frame except the frame number two and frame number five. In other words, the active mode is activated only during the frame number two and frame number five. At step 608, the method is terminated.

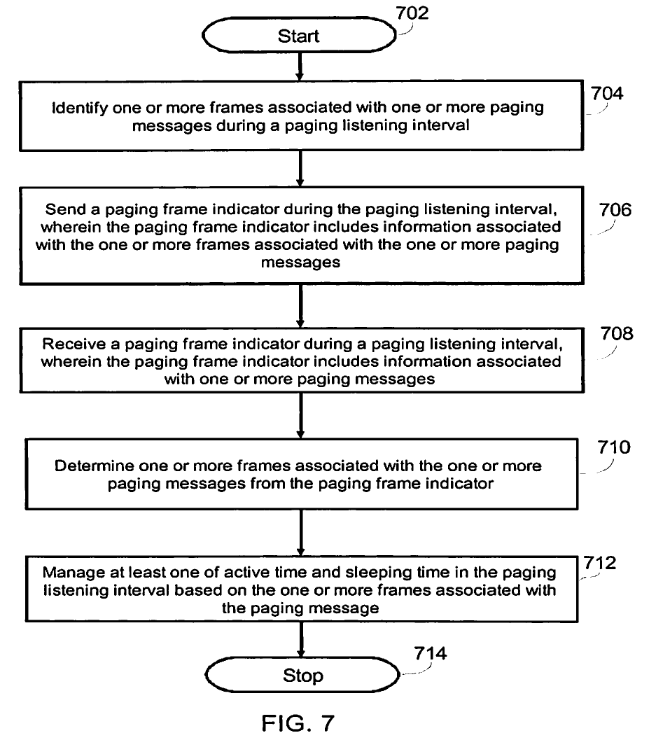

FIG. 7 illustrates a flow chart depicting a method for managing paging in a wireless communication network, in accordance with still another embodiment of the present invention. To explain the method 700, references will be made to FIG. 1 and FIG. 4. However, it will be apparent to a person ordinarily skilled in the art that the present embodiment can be explained with the help of any other suitable embodiment of the present invention. The method 700 can also include more or fewer number of steps as depicted in FIG. 7. Further, the order of the steps may also vary.

At step 702 the method 700 is initiated. In the environment 100, the BTS 102 receives a request from the communication device 104 for establishing communication channel with the communication device 106. At step 704, the BTS 102 after receiving the request identifies one or more frames associated with one or more paging messages. For example, the one or more frames in which a paging message can be sent to the communication device 106 are identified by the communication device. Thereafter, the information associated with the one or more frames in which the paging message can be sent is assembled in a Paging Frame Indicator (PFI).

At step 706, the BTS 102 then sends a PFI during the paging listening interval. In an embodiment, the paging frame indicator includes information about the one or more frames associated with the one or more paging messages. At step 708, the method 700 receives the PFI during a paging listening interval. In an embodiment, the communication device receives the PFI during the paging listening interval. For example, in the environment 400, the communication device 106 receives the PFI 406 during the paging listening interval 402.

At step 710, the method determines one or more frames associated with the one or more paging messages from the PFI. In an embodiment, the communication device 106 determines the one or more frames associated with the paging message from the PFI 406. As mentioned and depicted in FIG. 4, the communication device 106 identifies a frame 410 and a frame 412 from the PFI 406 received during the paging listening interval 404. Similarly, the communication device 106 determines frame 432 from the PFI 430 received during the paging listening interval 428.

At step 712, the method manages time period associated with at least one of active mode and sleep mode in the paging listening interval based on the one or more frames associated with the paging message. For example, in the environment 400, the communication device after determining the frames 408, 412, 432 manages time period associated with the sleep mode and active mode of the communication device 106.

For example, the communication device 106 during the paging listening interval 402 will be in active mode during the time interval corresponding to the frame 408, 412 and 432. Hence, the communication device during the paging listening interval 402 can be in sleep mode during the time frame corresponding to the frame in which the communication device 106 is not in active mode. Hence using this method, the sleep mode is activated for additional period of time. At step 714, the method 700 is terminated.

Various embodiments of the present invention described above provide the following advantages. The present invention provides a method for managing paging in a wireless communication network. The method allows the system to manage time period associated with sleep mode and active mode efficiently during the paging listening interval. Hence, the method helps the system to increase sleep mode and save battery energy. Thus, the battery power of the system can be conserved for additional period of time.

The method also achieves a higher battery standby time by minimizing active (wake-up) time without hindering the efficiency. Further the efficiency of the system is also increased, as the exact frame during which the paging message can be received and/or the frames during which the paging message will not be received are known earlier. The method can also be easily implemented in the communication technology without affecting the overall cost. The method increases efficiency of the overall communication system.

While the embodiments of the present invention have been illustrated and described, it will be clear that the present invention and its advantages are not limited to these embodiments only. Numerous modifications, changes, variations, substitutions and equivalents will be apparent to those skilled in the art without departing from the spirit and scope of the present invention as described in the claims.

We claim:

1. A method for managing paging in a wireless communication network, the method comprising:
receiving a paging frame indicator during a paging listening interval, wherein the paging frame indicator includes information associated with one or more paging messages;
determining one or more frames associated with the one or more paging messages from the paging frame indicator; and
managing time period associated with at least one of active mode and sleep mode during the paging listening interval based on the one or more frames.

2. The method of claim 1 further comprising periodically monitoring paging frame indicators during one or more paging listening intervals.

3. The method of claim 1, wherein determining the one or more frames comprises identifying one or more frames in which the paging message is received during the paging listening interval.

4. The method of claim 1 further comprising receiving the paging frame indicator in a first frame of the paging listening interval.

5. The method of claim 4, wherein receiving the paging frame indicator in a first frame comprises receiving the paging frame indicator in a first channel in the first frame of the paging listening interval.

6. The method of claim 4, wherein receiving the paging frame indicator in a first frame comprises receiving the paging frame indicator as a Type Length Value (TLV) field in a Downlink Medium Access Protocol (DL_MAP) message of the first frame of the paging listening interval.

7. The method of claim 1, wherein receiving the paging frame indicator comprises receiving information associated with one or more frames in a first bits format.

8. The method of claim 7, wherein receiving information associated with one or more frames in the first bit format comprises arranging one or more bits in the first bits format based on the one or more frames in which the paging message is received.

9. The method of claim 1, wherein managing paging in a wireless communication network comprises handling paging in at least one of the IEEE 802.16e standard and IEEE802.16m standard.

10. A method for managing paging in a wireless communication network, the method comprising:
identifying one or more frames associated with one or more paging messages during a paging listening interval; and
sending a paging frame indicator during the paging listening interval, wherein the paging frame indicator includes information associated with the one or more frames associated with the one or more paging messages.

11. The method of claim 10, wherein sending the paging frame indicator comprises transmitting the paging frame indicator in a first frame of the paging listening interval.

12. The method of claim 11, wherein transmitting the paging frame indicator in a first frame comprises sending the paging frame indicator in a first channel in the first frame of the paging listening interval.

13. The method of claim 11, wherein transmitting the paging frame indicator in a first frame comprises sending the paging frame indicator as a Type Length Value (TLV) field in a Downlink Medium Access Protocol (DL_MAP) message of the first frame of the paging listening interval.

14. The method of claim 10, wherein receiving the paging frame indicator comprises sending information associated with one or more frames associated with the one or more paging messages in a first bit format.

15. The method of claim 14, wherein the first bit format comprises arranging one or more bits in the first bit format based on the one or more frames in which the paging message is sent.

16. A system for managing paging in a wireless communication network, the system comprising;
a base transceiver station for transmitting a paging frame indicator during a paging listening interval, wherein the paging frame indicator includes information associated with one or more paging messages; and
a communication device for receiving the paging frame indicator from the base transceiver station, determining one or more frames associated with the one or more paging messages from the paging frame indicator, managing time period associated with at least one of active mode and sleep mode during the paging listening interval based on the one or more frames.

17. A base transceiver station comprising:
a processor to identify one or more frames associated with one or more paging messages during a paging listening interval; and
a transceiver to send a paging frame indicator during the paging listening interval, wherein the paging frame indicator includes information associated with the one or more frames associated with the one or more paging messages.

18. A communication device comprising:
a transceiver to receive a paging frame indicator during a paging listening interval, wherein the paging frame indicator includes information associated with one or more paging messages; and
a processor to:
determine one or more frames associated with the one or more paging messages from the paging frame indicator; and
manage time period associated with at least one of active mode and sleep mode during the paging listening interval based on the one or more frames.
